(19) United States
(12) Patent Application Publication
(10) Pub. No.: US 2025/0129929 A1
(43) Pub. Date: Apr. 24, 2025

(54) LIGHTED MIRROR

(71) Applicant: Kohler Co., Kohler, WI (US)

(72) Inventor: Douglas J. Diemel, JR., Kohler, WI (US)

(21) Appl. No.: 18/923,298

(22) Filed: Oct. 22, 2024

Related U.S. Application Data
(60) Provisional application No. 63/592,261, filed on Oct. 23, 2023.

(51) Int. Cl. F21V 33/00; F21S 9/02; F21V 5/04; F21V 23/04; F21Y 103/10; F21Y 113/00; F21Y 115/10

(52) U.S. Cl. CPC F21V 33/004; F21S 9/02; F21V 5/045; F21V 23/0471; F21Y 2103/10; F21Y 2113/00; F21Y 2115/10

(57) ABSTRACT

A mirror assembly includes a mirrored surface, at least one frosted edge disposed along a side of the mirror surface, a fresnel lens, and a light source configured to generate light. The fresnel lens is configured to refract a primary light path of the generated light, the refracted light traveling through the at least one frosted edge.

### CROSS-REFERENCE TO RELATED APPLICATION

This application claims priority benefit of Provisional Application No. 63/592,261 (Docket No. 010222-23062A) filed on Oct. 23, 2024, which is hereby incorporated by reference in its entirety.

### FIELD

The present disclosure relates generally to mirrors. More specifically, the present disclosure relates to lighted mirrors.

### BACKGROUND

Generally, lighted mirrors may be used in applications in which a user needs to perform detailed work (e.g., cosmetic applications) or carefully inspect one or more physical features (e.g., cosmetic, hygienic applications). In the above described applications, it is preferential that light generated by the mirror be directed toward and illuminate the user. Accordingly, there is a need for a lighted mirror that directs light inward, toward a user, particularly when a user leans inward or is otherwise close to the mirror.

### BRIEF DESCRIPTION OF THE DRAWINGS

Objects, features, and advantages of the present disclosure should become more apparent upon reading the following detailed description in conjunction with the drawing figures, in which:

FIG. 1 illustrates a lighted mirror assembly in accordance with one example of the present disclosure.

FIG. 2 illustrates a lighted mirror assembly in accordance with another example of the present disclosure.

FIG. 3 illustrates a lighted mirror assembly in accordance with another example of the present disclosure.

FIG. 4 illustrates a lighted mirror assembly in accordance with another example of the present disclosure.

FIG. 5 illustrates a lighted mirror assembly in accordance with another example of the present disclosure.

FIG. 6 illustrates a cross sectional view of the lighted mirror assembly of FIG. 1 taken along section line AA of FIG. 1.

FIG. 7 illustrates a cross sectional view of the lighted mirror assembly of FIG. 1 including a primary path of light generated by the mirror assembly.

FIG. 8 illustrates a lighted mirror assembly in accordance with one example of the present disclosure.

FIG. 9 illustrates a lighted mirror assembly in which light is not directed to toward a center of the mirror assembly.

FIG. 10 illustrates a system for controlling a lighted mirror assembly in accordance with one example of the present disclosure.

FIG. 11 illustrates a flow chart for controlling a lighted mirror assembly in accordance with one example of the present disclosure.

FIG. 12 illustrates an apparatus for controlling a lighted mirror assembly in accordance with one example of the present disclosure.

The figures illustrate certain examples of the present disclosure in detail. It should be understood that the present disclosure is not limited to the details and methodology set forth in the detailed description or illustrated in the figures. It should be understood that the terminology used herein is for the purposes of description only and should not be regarded as limiting.

### DETAILED DESCRIPTION

Described herein are lighted mirrors and methods of illuminating users of lighted mirrors. Specifically, described herein are lighted mirrors including a fresnel lens or fresnel optic configured to redirect or shift a primary path of light generated by a light source toward a center of a mirror. Specifically, the fresnel lens may refract light generated by the light source toward a center of the mirror assembly allowing more light energy to be directed to a user. In some examples, shifting a primary path of the light generated by the mirror assembly toward a center of the mirror may eliminate or reduce the size of one or more blind spots in which no light from the mirror assembly is received by a user.

Further, shifting the primary path of the light generated by the mirror assembly may allow more light energy to be directed toward a user improving the efficiency of the mirror assembly and increasing illuminance of the user. Specifically, the described lighted mirrors and methods of illuminating a user may achieve equivalent lux as a lighted mirror in which a primary path of light is not shifted toward a center of the mirror with substantially less power. Alternatively, the lighted mirrors described herein may achieve substantially higher lux than a lighted mirror in which the primary pathway of light is not shifted toward a center of the mirror assembly. In some examples, the lighted mirrors and methods of illuminating a user described herein may be used to increase a brightness or a battery length of a battery powered lighted mirror.

In some examples, the mirror assemblies described herein may include a mirrored surface and one or more frosted edges. Each of the frosted edges may be disposed along a side of the mirrored surface and is comprised of a transparent or semi-transparent material. In some examples, a frosted edge or frosted edges may surround a perimeter of the mirrored surface. In some examples, frosted edges may be disposed along two or more (e.g., opposite) edges of the mirrored surface. The mirror assemblies may further include a light source configured to generate light and a fresnel lens configured to refract a primary light path of the generated light toward a center of the mirrored surface. Specifically, light generated by the light source may be refracted by the fresnel lens toward a center of the mirror. The light refracted by the fresnel edge may then travel through the frosted edge of the mirror assembly towards a user. In some examples, two or more sides of a mirrored surface may include a light source, fresnel lens, and frosted edge such that a primary pathway of light generated by a light source on two or more sides of the mirrored surface may be redirected or shifted toward a center of the mirror.

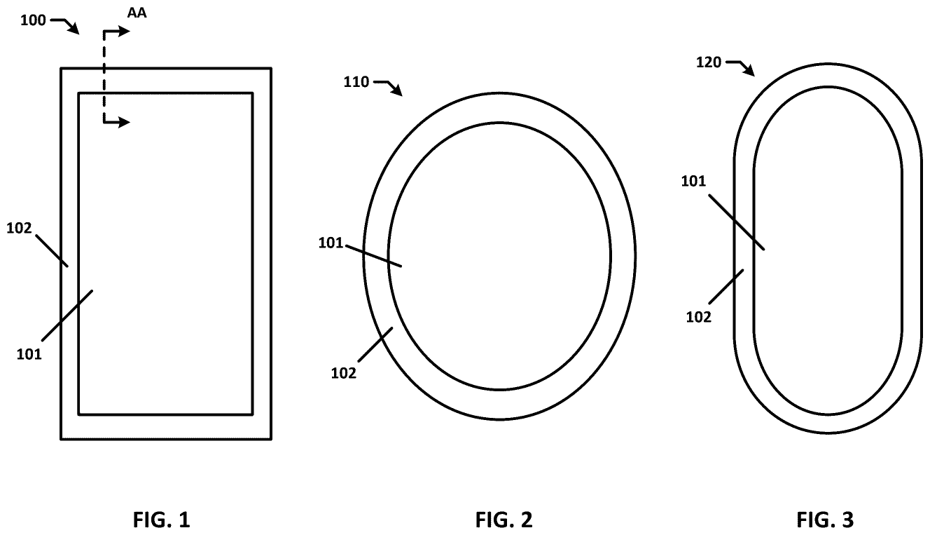

Referring generally to FIGS. 1-5, a plurality of mirror assemblies 100, 110, 120, 130, 140 according to examples of the present disclosure are illustrated. Each of the mirror assemblies 100, 110, 120, 130, 140 may include a mirror or mirrored surface 101 and one or more frosted edges 102. In some examples, the mirrored surface 101 and the frosted edge(s) 102 of the mirror assembly may be integrally formed. Specifically, the frosted edge(s) 102 may be an acid etched, sand-blasted, or laser etched portion of the mirror or mirrored surface 101. The frosted edge 102 may be semi-transparent (e.g., semi-clear) such that light (e.g., produced by a light source included in the mirror assembly) may travel through the frosted edge(s) 102. Each of the mirrored surface 101 and the frosted edge(s) 102 may form a portion of a front surface of the mirror assembly 100, 110, 120, 130, 140.

As described in greater detail below, each of the mirror assemblies 100, 110, 120, 130, 140 may include a fresnel lens configured to direct a primary light path of light generated by one or more light sources toward a center of the mirror (e.g., a center of the mirror assembly 100, 110, 120, 130, 140, a center of the mirrored surface 101). Specifically, light refracted by the fresnel lens may travel through the one or more frosted edges 102 of the mirror assembly 100, 110, 120, 130, 140 (e.g., toward a user). In some examples, the fresnel lens may be disposed adjacent to and directly behind frosted edges 102. For example, the fresnel lens may extend behind the frosted edges 102 along a length of the frosted edges 102.

In some examples, a mirror assembly 100, 110, 120, 130, 140 according to the present disclosure may be disposed in a bathroom. For example, the mirror assembly may be disposed above a vanity, above a sink (and/or faucet), and the like. In other examples, a mirror assembly 100, 110, 120, 130, 140 according to the present disclosure may be used in a different setting, for example, in a salon, healthcare facility, or the like. However, the present disclosure is not limited thereto and a mirror assembly 100, 110, 120, 130, 140 according to the present disclosure may be used in any setting and/or for any application.

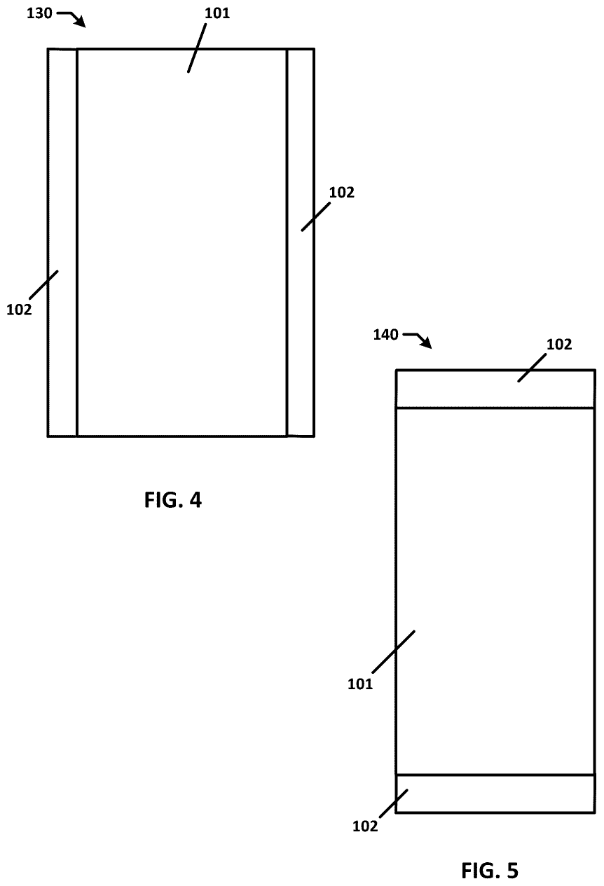

As illustrated in FIGS. 1-5, the size and/or shape of the mirrored surface 101 and the frosted edges 102 included in each of the mirror assemblies 100, 110, 120, 130, 140 may vary. In some examples, as illustrated in FIGS. 1, 4, and 5, the mirror assembly 100, 130, 140 may include a mirrored surface 101 having a rectangular shape. In other examples, the mirrored surface 101 may have another polygonal shape, for example, a pentagon or hexagon shape. In some examples, the one or more frosted edges 102 of the mirror assembly 100, 130, 140 may be linear. Specifically, when the mirrored surface 101 has a polygon shape, the frosted edges 102 may be linear. In some examples, as illustrated in FIG. 1, the mirror assembly 100 may include four frosted edges 102. In some examples, all sides of a polygon mirrored surface 101 may include frosted edges 102. In other examples, as illustrated in FIGS. 4 and 5, the mirror assembly 130, 140 may only include two frosted edges 102. For example, as illustrated in FIGS. 4 and 5, opposite sides of a rectangular mirrored surface 101 may include frosted edges 102. As illustrated in FIG. 4, a left and right (e.g., first and second) side of a rectangular mirrored surface 101 may include frosted edges 102. As illustrated in FIG. 5, a top and bottom (e.g., third and fourth) side of a rectangular mirrored surface may include frosted edges 102. Additional or fewer frosted edges 102 are possible for example, a mirror assembly may include a single frosted edge 102, three frosted edges 102, or more than four frosted edges 102. In some examples, the number of frosted edges 102 included in a mirror assembly may correspond to a number of sides of the mirrored surface 101.

In some examples, as illustrated in FIG. 2, the mirror assembly 120 may include a mirrored surface 101 having a circular shape. In other examples, the mirrored surface 101 may include another rounded shape, such as an ellipsoid or another shape. In some examples, for example, when the mirrored surface 101 has a circular shape, the one or more frosted edges 102 may be curved. For example, as illustrated in FIG. 2, the mirror assembly 110 may include a single frosted edge 102 circumscribing the circular mirrored surface 101. In other examples, the mirror assembly 110 may include one or more frosted edges 102 disposed around a portion or portions of the circular mirrored surface 101. For example, the frosted edges 102 may be spaced at regular or irregular intervals.

In other examples, as illustrated in FIG. 3, the mirror assembly 120 may include a mirrored surface 101 having an oblong or a pill shape. Specifically, as illustrated in FIG. 3, the mirrored surface 101 may have a shape including both linear and curved sides. In some examples, when the mirrored surface 101 that includes both linear and curved sides, the mirror assembly 120 may include both linear and curved frosted edges 102. Specifically, linear sides of the mirrored surface 101 may have linear frosted edges 102 and curved sides of the mirrored surface 101 may have curved frosted edges 102. As illustrated in FIG. 3, all of the sides of the mirrored surface 101 include a frosted edge 102; however, the present disclosure is not limited thereto. For example, only one set of opposite sides (e.g., top and bottom, left and right) may include frosted edges 102. In other examples, three sides or only a single side of the mirrored surface 101 may include frosted edges 102.

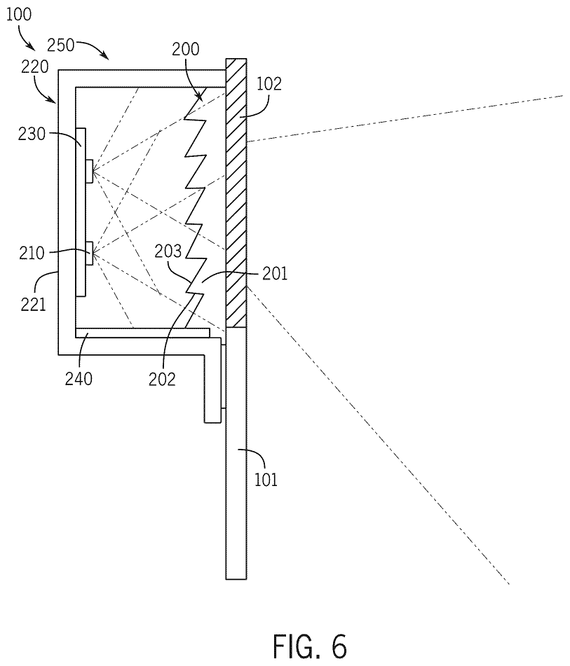

Referring to FIG. 6, a cross sectional view of the mirror assembly 100 of FIG. 1 taken along section line AA of FIG. 1 is illustrated. As illustrated in FIG. 6, the mirror assembly 100 may include a mirrored surface 101 and a frosted edge 102. The mirrored surface 101 and frosted edge 102 may collectively form a front surface of the mirror assembly 100. Further, as illustrated in FIG. 6, the mirror assembly 100 may include a fresnel lens 200, a light source 210, a housing 220, a printed circuit board (PCB) assembly 230, and a reflective surface 240. The fresnel lens 200, light source 210, housing 220, PCB assembly 230, and reflective surface 240 may be collectively referred to herein as a light assembly 250.

Although described with respect the mirror assembly 100 of FIG. 1, the light assembly 250 described herein may be included in any of the mirror assemblies 100, 110, 120, 130, 140 described herein. Specifically, the light assembly 250 may be disposed behind (e.g., adjacent to) the frosted edges 102 of any of the mirror assemblies 100, 110, 120, 130, 140 described herein. In some examples, the light assembly 250 may extend along an entire length of the each of the frosted edges 102. In other examples, the light assembly 250 may extend behind a portion or portions of the frosted edges 102 of each of the mirror assemblies 100, 110, 120, 130, 140. Specifically, in some examples, the light assembly 250 may have a curved shape corresponding to one or more curved frosted edges 102 included in the mirror assembly 110, 120.

Returning to FIG. 6, the fresnel optic or fresnel lens 200 may be configured to refract or shift the primary path of light generated by the light source 210 toward a center of the mirror assembly 100 (e.g., mirrored surface 101). The fresnel lens 200 may include a plurality (e.g., two or more) optical elements 201 disposed along or protruding from a side of the fresnel lens 200. Each of the optical elements 201 may be configured or arranged so as to refract light generated by the light source 210 toward a center of the mirror assembly 100 (e.g., mirrored surface 101). Specifically, the optical elements 201, collectively, may be configured or arranged so as to achieve the same or a similar effect as a substantially larger optic or lens having a similar (e.g., same shape but different size) but substantially larger optic or lens. The fresnel lens 200 may reduce the amount of material required by dividing a larger, conventional lens into a series of sections or optical elements 201, effectively dividing a continuous surface of the larger, conventional lens into a set of surfaces with the same orientation (e.g., angled surface) or curvature with stepwise discontinuities between them. Using a fresnel lens 200 may advantageously reduce material costs, reduce the size of, and improve manufacturability of the mirror assembly 100. Specifically, in some examples, when a mirror assembly 110 has a circular frosted edge 102, the fresnel lens 200 may include a plurality of concentric optical elements 201. In other examples, where the mirror assembly 100, 120, 130, 140 includes straight frosted edges 102, the optical elements 201 disposed on each side of the mirror assembly 100, 110, 120, 130, 140 may be parallel to one another (e.g., in a linear array). The fresnel lens 200 may extend behind the frosted edges 102 of the mirror assembly 100 and refract light through the frosted edges 102 toward a center of the mirror assembly 100.

In some examples, as illustrated in FIG. 6, the optical elements 201 may have a substantially triangular shape including a rounded corner. However, the shape of the optical elements 201 is not limited thereto. For example, the optical elements 201 may have a curved (e.g., arcuate) shape or polygon shape. Further, as illustrated in FIG. 6, in some examples, the plurality of optical elements 201 may be arranged in a linear array (e.g., a plurality of rows, columns). Each of the optical elements 201 included in a linear array may have the same size and/or shape. According to other examples, a linear array of optical elements may have varying shapes and or sizes.

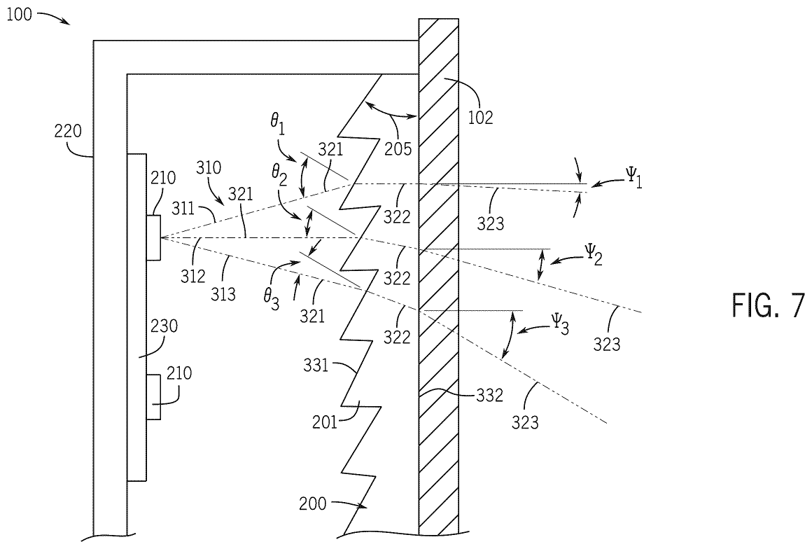

In some examples, as illustrated in FIG. 6, the optical elements 201 may have a triangular or substantially triangular shape. Further, as shown, the optical elements 201 may be arranged such that a base 202 of the triangular optical element 201, perpendicular to the frosted edge 102, is disposed closer (e.g., more proximate) to the mirrored surface 101 (e.g., a center of the mirrored surface 101) and the hypotenuse 203 of the triangular optical element 201 extends from the base 202 in a direction away from the mirrored surface 101 (e.g., a center of the mirrored surface 101). In some examples, an angle 205 of hypotenuse 203 of the optical element 201 may be approximately 30 degrees relative to front surface of the frosted edge 102 and/or a front surface of the mirrored surface 101 of the mirror assembly 100 (see FIG. 7). In some examples, an angle 205 of the hypotenuse 203 may be between 15 degrees and 45 degrees relative to a front surface of the frosted edge 102 and/or a front surface mirrored surface 101.

In some examples, the fresnel lens 200 may be disposed (e.g., behind the frosted edge 102) around the perimeter of the mirror assembly 100. Specifically, in addition to being disposed horizontally, as illustrated in FIG. 6, the fresnel lens 200 and optical elements 201 may be disposed vertically. Similarly, to when the fresnel lens 200 and optical elements 201 are disposed horizontally, a base 202 of the optical elements 201 may be disposed closer to the mirrored surface 101 (e.g., center of the mirrored surface 101) than the hypotenuse 203 of the optical element 201 when the fresnel lens 200 and optical elements 201 are arranged vertically (e.g., on a left or right side of the mirrored surface). In some examples, the fresnel lens 200 may be comprised of one or more sections arranged around the mirror assembly (e.g., behind the frosted edge 102).

In some examples, the fresnel lens 200 may be comprised of a silicone or acrylic material. Specifically, in some examples, the plurality of optical elements 201 may be integrally formed with the fresnel lens 200 as a single unitary body. The fresnel lens 200 may be, for example, an acrylic or silicone molded component.

As illustrated in FIG. 6, the mirror assembly 100 may further include a light source 210. In some examples, as illustrated in FIG. 6, the light source 210 may be a light emitting diode (LED) array. In some examples, the (LED) array may extend along a length of the frosted edge 102 and/or along a length of the fresnel lens 200. In some examples, the light source 210 may include two or more arrays (e.g., rows, columns) of LEDS extending along the length of the frosted edge(s) 102 and/or of fresnel lens 200. In other examples, the light source 210 may be a single LED or a fluorescent, incandescent, or halogen light source. In some examples, the light source 210 may be present at or along only a portion of the frosted edge 102 and/or along only a portion of the fresnel lens 200. In some examples, a central portion of the primary path of light generated by the light source may be perpendicular to a front surface of the frosted edge 102 and/or a front surface of the mirrored surface 101, such that the fresnel lens 200 and/or frosted edge 102 is directly lit by the light source.

In some examples, the mirror assembly 100 may further include a printed circuit board (PCB) assembly 230. The PCB assembly 230 may extend behind the light source 210 (e.g., behind the frosted edge(s) 102, fresnel lens 200). The PCB assembly 230 may be configured to provide power (e.g., electric current) and/or one or more control signals to the light source 210. In some examples, the PCB assembly 230 may by flexible and may include a core comprised of a flexible polymer. The PCB assembly 230 may be coupled to the back wall 221 of the housing 220. For example, a glue or adhesive, double sided tape, or the like may be used to couple the PCB assembly 230 and the housing 220. The PCB assembly 230 may be disposed between the back wall 221 and the light source 210.

In some examples, as illustrated in FIG. 6, the mirror assembly 100 may further include a housing 220. The housing 220 may be disposed behind the frosted edge(s) 102 and/or mirrored surface 101 of the mirror assembly 100. In some examples, as illustrated in FIG. 6, the housing 220 may have a substantially “C” shape and extend around the mirror assembly 100 behind the frosted edge(s) 102 of the mirror assembly 100. As illustrated in FIG. 6, in some examples, the fresnel lens 200, light source 210, and PCB assembly 230 may be disposed in the housing 220. Specifically, in some examples, the fresnel lens 200 may be disposed in an open portion of the substantially “C” shaped housing 220. Specifically, as shown in FIG. 6, when the fresnel lens 200 is disposed in the housing 220, the fresnel lens 200 may engage (e.g., contact, abut) a pair of opposite sides of the housing 220, for example, top and bottom side of the channel of the housing 220 as illustrated in FIG. 6 or left and right sides of a channel extending vertically along a side of the mirror assembly 100, 120, 130, 140.

According to some examples, the fresnel lens 200 may be coupled to the housing 220. For example, an interference fit connection, such as a press fit connection may be used to couple the fresnel lens 200 and the housing 220. According to other examples, a glue or adhesive, double sided tape, or one or more fasteners (e.g., screws, bolts, rivets, or the like), or a combination thereof may be used to couple the fresnel lens 200 and the housing 220. Further, the in some examples, the light source 210 may be disposed on a back wall 221 of the housing 220, such that light (e.g., a primary path of light) generated by the light source 210 is radiated directly onto the fresnel lens 200. In some examples, the housing 220 may be comprised of a plastic. In some examples, the housing 220 may be injection molded. The light source 210 may be coupled to the housing 220 for example, using a glue or adhesive, double sided tape, or the like.

In some examples, the mirror assembly 100 may further include one or more reflective surfaces 240. As illustrated in FIG. 6, the reflective surface 240 may be an interior surface of the housing 220. The one or more reflective surfaces 240 may be configured to reflect light, in order to maximize a quantity of light refracted through the fresnel lens 200 and/or frosted edge(s) 102. In some examples, the reflective surface may be a highly reflective white coating (e.g., paint), for example, a 95% reflective white coating. In other examples, the reflective surface 240 may be comprised of a highly reflective white polyethylene terephthalate (PET) (95% reflective) material. In these examples, the reflective surface 240 may be coupled to an interior surface of the housing 220.

Referring to FIG. 7, a cross-sectional view of the mirror assembly 100 in accordance with one example of the present disclosure is illustrated. Specifically, FIG. 7 illustrates a primary light path 310 in accordance with one example of the present disclosure. The primary light path 310 may include a first boundary component 311, a central component 312, and a second boundary component 313. Specifically, the fresnel lens 200 is configured to refract the primary light path 310 toward a center of the mirror assembly 100 (e.g., mirrored surface 101). As illustrated in FIG. 7, a fresnel lens 200 disposed along a top side of the mirrored surface 101 may be configured to direct light generated by the light source 210 downward towards a center of the mirror assembly 100 (e.g., mirrored surface 101). Similarly, when a fresnel lens 200 is disposed along a left or right side of the mirrored surface 101, the fresnel lens 200 may direct the light inward (e.g., to the right or left, respectively) toward a center of the mirror assembly 100. Further, when a fresnel optic is disposed along a bottom side of the mirrored surface 101, the fresnel lens 200 may direct the light upward toward a center of the mirror assembly 100.

Specifically, FIG. 7 illustrates a first portion 321 (of each of the first boundary component 311, central component 312, and second boundary component 313) of the primary light path 310 traveling from the light source 210 to a first multimedia interface 331, which is an interface between air disposed in the housing 220 and the fresnel lens 200. Further, FIG. 7 illustrates a second portion 322 (of each of the first boundary component 311, central component 312, and second boundary component 313) of the primary light path 310 traveling from the first multimedia interface 331 to second multimedia interface which is an interface between the fresnel lens 200 and the frosted edge 102 of the mirror assembly. Additionally, FIG. 7 illustrates a third portion 323 (of each of the first boundary component 311, central component 312, and second boundary component 313) of the primary light path traveling from the second multimedia interface 332 toward a user. In some examples, the light may refract again at a third multi media interface between the frost edge 102 and air in front of the mirror assembly 100.

As will be discussed in more detail below, the light will refract at the different multimedia interfaces 331, 332 according to Snell's Law of Refraction. Snell's Law provides that when a light ray enters a different medium, its speed and wavelength change. As a result, the ray (1) bends towards the normal of the media interface when the ray's speed decreases in the new medium, or (2) bends away from the normal of the media interface when the ray's speed increases in the new medium. The angle of refraction depends on the indices of refraction of both media:

$${n}_{1} sin ( Φ ) = {n}_{2} sin ( Ψ )$$

where n1 is the refractive index of the first medium (from which the ray travels), n2 is the refractive index of the second medium (into which the ray travels), ϕ is the angle of incidence (the angle between the normal line to the interface boundary between the two media and the ray traveling through the first medium), and W is the angle of refraction (the angle between the normal line to the interface boundary and the ray traveling through the second medium).

As illustrated in FIG. 7, according to Snell's Law and the changing refractive indices of the different mediums of travel, the primary light path 310 will bend or shift toward a center of the mirrored surface 101 at each of the first multimedia interface 331 and second multimedia interface 332. An angle of incidence ϕ of a first portion 321 of each of the first boundary component 311, central component 312, and second boundary component 313 at the first multimedia interface 331 and an angle of refraction Y of the first boundary component 311, central component 312, and second boundary component 313 at the second multimedia interface 332 are illustrated.

Specifically, according to one example, an angle of incidence ϕ₁ of the first boundary component 311 at the first multimedia interface 331 may be 45.40 degrees, and angle of incidence ϕ₂ of the of the central portion 312 at the first multimedia interface 331 may be 30.40 degrees, and an angle of incidence ϕ₃ of the second boundary component 313 at the first multimedia interface may be 15.40 degrees. Further, according to one example, an angle of refraction at the second multimedia interface may be an angle ψ₁ of 2.76 degrees for the first boundary component 311, an angle of ψ₂ of 15.81 degrees for the central component, and an angle ψ₃ of 30.84 degrees for the second boundary component 313. Accordingly, as illustrated in FIG. 7, the fresnel lens 200 may refract the primary path 310 of light generate toward a center of the mirror assembly 100.

As described above and illustrated in FIG. 7, the fresnel lens 200 has an orientation such that light from the light source 210 incident on the fresnel lens 200 is refracted toward a center of the mirrored surface 101 or mirror assembly 100, 110, 120, 130, 140, for example, reducing power consumption, increasing light intensity, and/or improving task lighting. However, the present disclosure is not limited thereto, and in other examples, the optical elements 201 of the fresnel lens 200 may have a different orientation, such as a triangular shape including a base and a hypotenuse extending from the base toward a center of the mirror assembly 100, 110, 120, 130, 140 (e.g., mirrored surface 101) and toward the frosted edge 102, such that the fresnel lens 200 refracts light incident thereon away from a center of the mirror assembly 100, 110, 120, 130, 140 (e.g., mirrored surface 101).

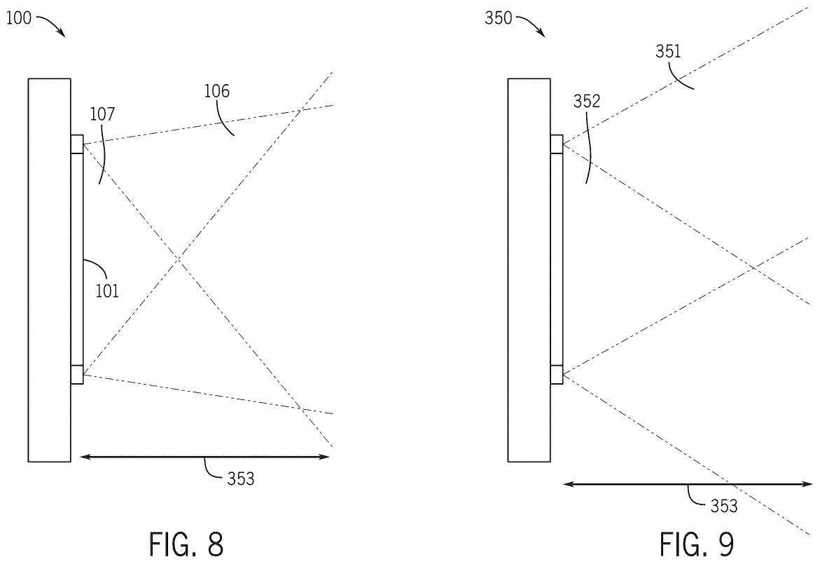

Referring to FIG. 8 a diagram illustrating light 106 radiated from a mirror assembly 100 in accordance with one example of the present disclosure is illustrated. Specifically, FIG. 8 illustrates a blind spot 107 in which light 106 radiated from the mirror assembly 100 may not be received by a user or an object disposed in front of the mirror assembly 100. Referring to FIG. 9, a diagram illustrating light 351 radiated from a light assembly 350 in which light is not refracted (e.g., by a fresnel lens 200) toward a center of the mirror assembly 350 is provided. Specifically, FIG. 9 illustrates a blind spot 352 in which light 351 radiated from the mirror assembly 350 may not be received by a user or an object disposed in front of the mirror assembly 350.

Specifically, as illustrated in FIGS. 8 and 9, the blind spot 107 of a mirror assembly 100 in which light 106 is directed (e.g., refracted) toward a center of the mirror assembly 100 is significantly smaller than a blind spot 352 of a mirror assembly 350 in which light 351 is not directed (e.g., refracted) toward a center of the mirror assembly 350. Accordingly, in addition to increasing a quantity of light energy directed toward a user, the mirror assembly 100 in which light is directed toward a center of the mirror assembly may reduce the size of a blind spot in which light is not received by a user or an object disposed in front of the mirror assembly 100. Specifically, the mirror assembly 100 may reduce a distance between a front surface of the mirrored surface 101 and light 106 radiated by the mirror assembly 100 at a center of the mirrored surface 101. A reference distance 353 is illustrated in each of FIGS. 8 and 9. As shown by reference distance 353 in FIGS. 8 and 9, a distance between a front surface of the mirrored surface 101 and/or the light 106 and light 106 radiated by the mirror assembly 100 at a center of the mirrored surface 101 is smaller than a distance between a front surface of the mirror assembly 350 and light radiated by the mirror assembly 350 at a center of the mirrored surface of the light assembly 350. Accordingly, the mirror assembly 100 may allow a user to get closer to the mirror assembly 100 while still receiving light 106 from the mirror assembly 100. Accordingly, the mirror assembly 100 may advantageously allow a user to get close to the mirror, for example, while performing detailed cosmetic or hygienic work while still being illuminated by the mirror assembly 100.

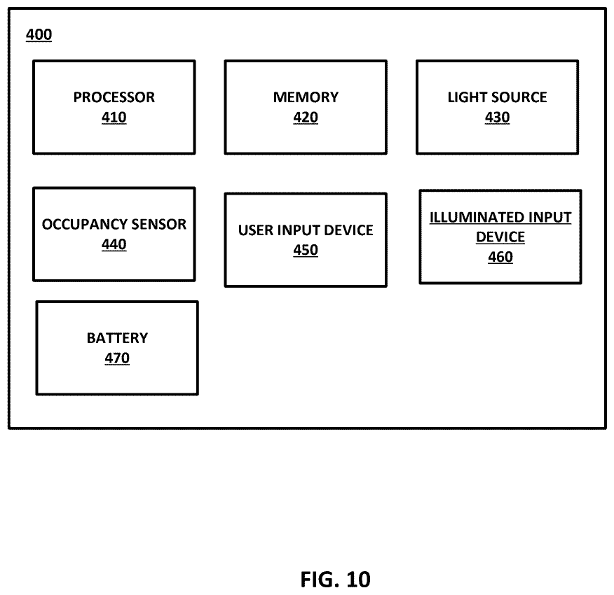

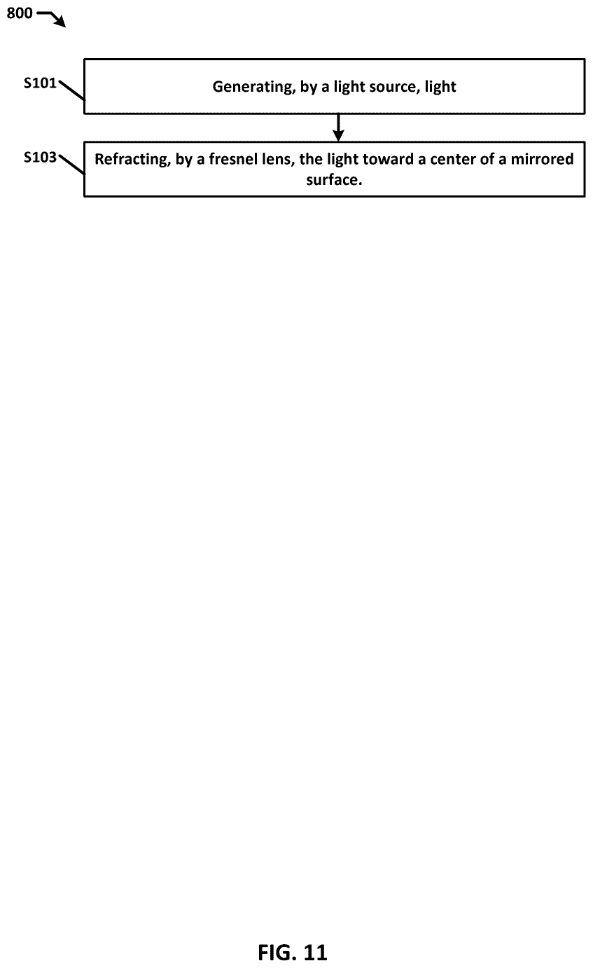

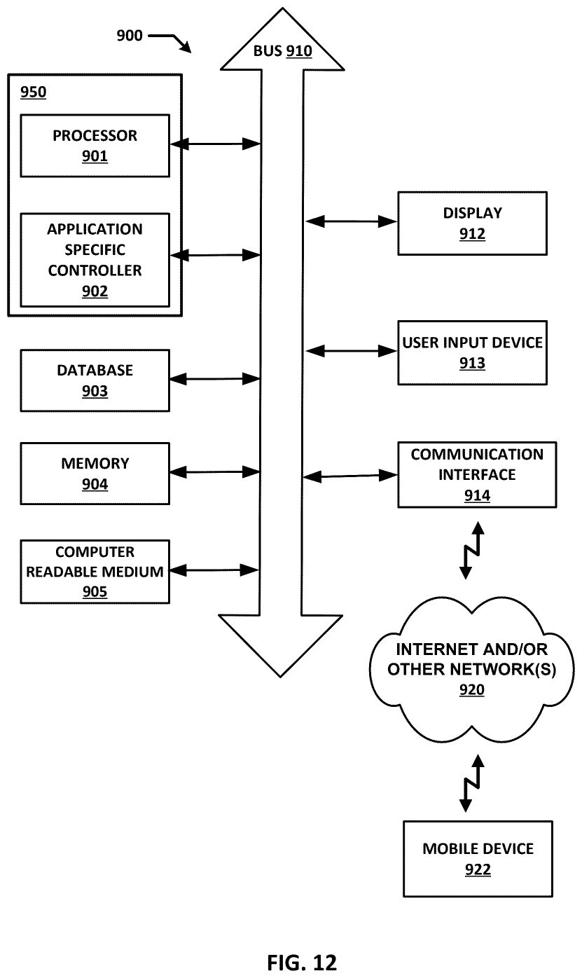

Referring to FIG. 10, a system 400 for controlling a mirror assembly 100, 110, 120, 130, 140 in accordance with one example of the present disclosure is illustrated. As illustrated in FIG. 9, the system 400 may include a processor 410, memory 420 and a light source 430. In some examples, the system 400 for controlling the mirror assembly 100, 110, 120, 130, 140 may further include one or more of an occupancy sensor 440, a user input device 450, an illuminated input device 460, and a battery 470.

The processor 410 and memory 420 may be configured to control any of the mirror assemblies 100, 110, 120, 130, 140 described herein. Specifically, the memory 420 may store one or more sets of rules or algorithms for controlling the light source 430 and the processor 410 may implement or execute the one or more sets of rules or algorithms. The light source 430 may be the same as the light source 210 described above with respect to FIGS. 6 and 7.

In some examples, the system 400 for controlling a mirror assembly 100, 110, 120, 130, 140 may include an occupancy sensor 440. In some examples, the occupancy sensor 440 may be an optical sensor, for example, an infrared or microwave sensor. In other examples, another type of sensor, for example, an ultrasonic sensor may be user. In some examples, the occupancy sensor may be disposed behind the mirrored surface 101 of the mirror assembly 100, 110, 120, 130, 140. Specifically, in some examples, a portion of the mirrored surface 101 may include a two-way mirror or two-way glass such that the occupancy sensor 440 (e.g., an optical sensor) is able to sense or detect the presence of a user in front of the mirror assembly without a user seeing the occupancy sensor 440 or a change in the appearance of the mirrored surface 101 (e.g., between the portion of the mirrored surface include two-way glass and the rest of the mirrored surface 101).

The occupancy sensor 440 may be in communication with the processor 410 and/or the memory 420. Specifically, the occupancy sensor 440 may transmit or send sensor data to the processor 410 and/or memory 420. The processor 410 and/or memory 420 may be configured to receive the sensor data. The processor 410 may be configured to analyze the sensor data and control the light source 430 based at least in part on the sensor data. The processor may control the light source 430 by sending one or more control signals and/or selectively providing power (e.g., electric current) to the light source 430. In some examples, the processor 410 may control a brightness of light generated by the light source by increasing power or electric current supplied to the light source 430.

In some examples, the processor 410 may control the light source 430 so as to turn the light source on when the sensor date indicates that a user is approaching or near the mirror assembly. In another example, the processor 410 may control the light source 430 so as to increase an intensity or brightness of light generated by the light source 430 when the sensor data indicates that a user is approaching or near the mirror assembly. Conversely, in some examples, the processor 410 may control the light source 430 so as to turn off the light source 430 off or reduce the intensity or brightness of light generated by the light source 430 when the sensor data indicates that a user is departing from the mirror assembly or that a user is not proximate to the mirror assembly.

In some examples, the system 400 for controlling a mirror assembly 100, 110, 120, 130, 140 may further include a user input device 450. The user input device 450 may be configured to transmit on or more user input signals to the processor 410 in response to actuation by a user. In some examples, the user input device 450 may included in the mirror assembly 100, 110, 120, 130, 140, such that, for example, the user input device 450 is disposed along a side of the mirror assembly 100, 110, 120, 130, 140. The user input device 450 may include tactile (e.g., movable) buttons and/or one or more sensors (e.g., capacitive) configured to receive an input from a user when a user is proximate to the sensor. The processor 410 may be configured to receive the user input signals from the user input device 450 and may control the light source 430 in accordance with the various input signals. For example, the processor 410 may control the light source 430 so as to turn on (e.g., generate light), turn off (e.g., stop generating light), increase the intensity of light generated, decrease the intensity of light generated, and the like in response to user input signals.

In one example, the user input device 450 may comprise a tactile button or a sensor configured to receive a user input and send a user control signal to the processor 410 in response the user input. In this example, the user control signal may be a signal instructing the processor 410 to enter a “boost mode” in which the intensity of light generated by the light source 430 is increased for a predetermined period of time. The processor 410, upon receipt of the user control signal, may send one or more control signals to the light source 430 causing the light source 430 to generate light having an increased intensity or brightness for a predetermined period of time and/or may increase the quantity of power or electric current supplied to the light source 430 for a predetermined period of time. Increasing the intensity of light generated by the light source 430 for a predetermined period of time during a “boost mode” may advantageously decrease power consumption of the mirror assembly 100, 110, 120, 130, 140 by limiting a duration of time during which light having increased intensity is emitted from the light source. Said reduction in power consumption may advantageously allow or facilitate a battery powered mirror assembly 100, 110, 120, 130, 140.

In some examples, the system 400 for controlling a mirror assembly 100, 110, 120, 130, 140 may further include an illuminated input device 460. Similar to the user input device 450, the illuminated input device 460 may be configured to receive a user input and transmit a user control signal to the processor 410 based on the user input. Additionally, similar to the user input device 450, the illuminated input device 460 may be disposed along a side of the mirror assembly 100, 110, 120, 130, 140 and include tactile buttons and/or a sensor (e.g., capacitive sensor) configured to receive an input when a user is proximate to the sensor. The illuminated input device 460 may include a secondary light source configured to generate light at a location of the illuminated input device 460 indicating a location of the illuminated input device 460. In some examples, the illuminated input device 460 may generate light when the (e.g., primary) light source 210, 430 is turned off or not generating light. Additionally, in some examples, the illuminated input device 460 may be disposed on a bottom side of the mirror assembly 100, 110, 120, 130, 140 such that light generated by the illuminated input device 460 illuminates a faucet and/or basin disposed below the mirror assembly 100, 110, 120, 130, 140. According to some examples, the secondary light source may illuminate a surface (e.g., wall) behind or adjacent to the illuminated input device 460.

The processor 410 may control the light source 430 in accordance with the user control signals received from the illuminated input device 460. For example, the processor 410 may control the light source 430 so as to turn on (e.g., generate light), turn off (e.g., stop generating light), increase the intensity of light generated, decrease the intensity of light generated, and the like in response to user input signals.

In some examples, in addition to receiving sensor data from the occupancy sensor 440 and/or user control signals from the user input device 450 and/or illuminated input device 460, the processor 410 may receive control signals from a wall switch (e.g., located in a room including the mirror assembly 100, 110, 120, 130, 140. In some examples, a control signal or control signals received from the wall switch may be configured to reset the mirror assembly 100, 110, 120, 130, 140 so as to generate light having a standard or preset intensity. For example, when the wall switch is toggled off and then back on, the processor 410 may control the light source 430 to generate light in a default mode (e.g., having a standard or predetermined intensity).

In some examples, the system 400 for controlling a mirror assembly 100, 110, 120, 130, 140 may further include a battery 470. The battery 470 may be in communication with the processor 410 and the light source 430. The battery 470 may be configured to provide power (e.g., electric current) to the light source 430. In some examples, the battery 470 may supply power to the light source 430 in response to one or more control signals from the processor 410. In other examples, the battery 470 may continuously supply power to the light source 430. In some examples, the battery 470 may be a rechargeable battery 470. In some examples, the mirror assembly 100, 110, 120, 130, 140 may be configured such that the battery 470 may be recharged (e.g., using a cord and a wall outlet adapter) without moving the mirror assembly 100, 110, 120, 130, 140 and/or without removing the battery 470 from the mirror assembly 100, 110, 120, 130, 140. In other examples, the battery 470 may be removable from the mirror assembly 100, 110, 120, 130, 140 for charging (e.g., recharging).

In some examples, the fresnel lens 200 described above and included in the mirror assemblies 100, 110, 120, 130, 140 may advantageously increase the efficiency of the mirror assemblies 100, 110, 120, 130, 140 significantly reducing an amount of power required to illuminate a user, making a battery powered mirror assembly a more viable solution for task lighting. According to some examples, the above described “boost mode” may further reduce power consumption of the mirror assembly 100, 110, 120, 130, 140 facilitating a battery powered mirror assembly task lighting solution.

Referring to FIG. 10, a flowchart 800 for controlling a mirror assembly in accordance with one example of the present disclosure is illustrated. The flowchart 800 for controlling a mirror assembly may be used with any of the mirror assemblies 100, 110, 120, 130, 140 described herein. Additional, different, or fewer acts may be provided.

In a first act S101, light may be generated by a light source 210. Specifically, a processor 410 as described above with respect to the system 400 for controlling a mirror assembly may provide one or more control signals and/or electric current to a light source 210, 430 causing the light source to generate light in response to one or more of control signals from a wall switch, sensor data from an occupancy sensor 440, and/or user control signals from a user input device 450 and/or illuminated input device 460.

In a second act S103, light may be refracted by a fresnel lens 200 toward a center of a mirror assembly 100, 110, 120, 130, 140 (e.g., mirrored surface 101). Specifically, light emitted by the light source 210 incident on the fresnel lens 200 may be refracted at the first multimedia interface 331 between air disposed in the housing 220 and the fresnel lens 200, such that a primary path of the light is bent or shifted toward a center of the mirror assembly 100, 110, 120, 130, 140 or mirrored surface 101. According to some examples, light emitted by the light source 210 may additionally be refracted such that a primary pathway thereof is bent or shifted toward a center of the mirror assembly 100, 110, 120, 130, 140 or mirrored surface 101 at a second multimedia interface between the fresnel lens 200 and the frosted edge 102 and/or a third multimedia interface between the frosted edge 102 and air disposed in front of the frosted edge 102. The light generated by the light source 210 may be refracted as described above with respect to FIGS. 5 and 6.

Referring to FIG. 9, an apparatus 900 for controlling a mirror assembly (e.g., 100, 110, 120, 130, 140) in accordance with one example of the present disclosure is illustrated. In some examples, the apparatus 900 may be implemented as the system 400 for controlling a mirror assembly. The apparatus 900 includes a bus 910 facilitating communication between a controller 950 that may be implemented by a processor 901 and/or application specific controller 902 and one or more components including a database 903, a memory 904, a computer readable medium 905, display 912, a user input device 913, and a communication interface 914. The processor 901 and memory 904 may be configured to perform the same functions as the processor 410 and memory 420 described above with respect to the system 400 for controlling a mirror assembly.

The contents of the database 903 may include, for example, one or more light settings (e.g., on, off, intensity or brightness, duration) associated with or corresponding to sensor data, user control signals, or control signals received by the processor 901. The memory 904 may be a volatile memory or a non-volatile memory. The memory 904 may include one or more read only memory (ROM), random access memory (RAM), a flash memory, an electronic erasable program read only memory (EEPROM), or other type of memory. The memory 904 may be removable from the apparatus 900, such as a secure digital (SD) memory card.

The memory 904 and/or the computer readable medium 905 may include a set of instructions that can be executed to cause the controller to perform any one or more of the methods or computer-based functions disclosed herein. For example, the controller 950 may send one or more controller signals and/or electric current to the light source 210, 430 performing various acts of the flowchart 800 and/or the various functionality described above with respect to the system 400 for controlling a mirror assembly.

A user may enter a new light setting (e.g., brightness, duration) using the display 912 and/or user input device 913. The display 912 may comprise a screen and the user input device 913 may comprise one or more buttons on the apparatus 900. In some examples, the display 912 and user input device 913 may comprise a touch sensitive surface (i.e., a touch screen). In some examples, the user input device 913 may include a microphone configured to receive one or more verbal or voice activation commands for controlling the mirror assembly.

The communication interface 914 may be connected to the network 920, which may be the internet. In some examples, the network 920 may be connected to one or more mobile devices 922. The one or more mobile devices may be configured to send a signal to the communication interface 914 via the network 920. For example, one or more mobile devices may send a signal to the communication interface to enter a new light setting (e.g., brightness, duration)

The communication interface 914 may include any operable connection. An operable connection may be one in which signals, physical connections and/or logical communications may be sent and/or received. An operable connection may include a physical interface, an electrical interface, and/or a data interface. The communication interface 914 provides for wireless and/or wired communications in any known or later developed format.

When a component, device, element, or the like of the present disclosure is described as having a purpose or performing an operation, function, or the like, the component, device, or element should be considered herein as being “configured to” meet that purpose or to perform that operation or function.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the system as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A mirror assembly comprising:
a mirrored surface;
at least one frosted edge disposed along a side of the mirrored surface;
a fresnel lens; and
a light source configured to generate light, wherein the fresnel lens is configured to refract a primary light path of the generated light and the refracted light travels through the at least one frosted edge.

2. The mirror assembly of claim 1, wherein the fresnel lens is configured to refract the primary light path of the generated light toward a center of the mirrored surface.

3. The mirror assembly of claim 1, wherein the fresnel lens is configured to refract the primary light path of the generated light away from a center of the mirrored surface.

4. The mirror assembly of claim 1, wherein the fresnel lens abuts the at least one frosted edge.

5. The mirror assembly of claim 1, wherein the at least one frosted edge includes one or more frosted edges disposed along an entire perimeter of the mirrored surface.

6. The mirror assembly of claim 1, wherein the light source comprises a plurality of rows of light emitting diodes (LEDs) disposed along the at least one frosted edge.

7. The mirror assembly of claim 1, further comprising:
an occupancy sensor configured to collect occupancy data; and
a processor configured to analyze the occupancy data and control the light source based at least in part on the occupancy data.

8. The mirror assembly of claim 10, wherein the occupancy sensor is disposed behind the mirrored surface.

9. The mirror assembly of claim 1, further comprising:
a user input device; and
a processor configured to receive a user control signal from the user input device and control the light source to increase an illuminance of the light generated by the light source for a predetermined period of time in response to the user control signal.

10. The mirror assembly of claim 1, further comprising:
an illuminated input device; and
a processor configured to receive a user control signal from the illuminated input device and control the light source based at least in part on the user control signal.

11. The mirror assembly of claim 10, wherein the illuminated input device is configured to illuminate at least one of a faucet disposed below the mirror assembly and a basin disposed below the mirror assembly.

12. The mirror assembly of claim 1, further comprising:
a battery configured to supply power to the light source.

13. The mirror assembly of claim 1, further comprising:
a housing disposed behind the at least one frosted edge including the light source or the fresnel lens.

14. A mirror assembly comprising:
a mirrored surface;
a pair of frosted edges disposed along opposite sides of the mirrored surface;
a pair of fresnel lenses, a respective one of the pair of fresnel lens disposed along each of the pair of frosted edges; and
at least one light source configured to generate light, wherein the pair of fresnel lenses are configured to refract a primary light path of the generated light toward a center of the mirrored surface, the refracted light traveling through the pair of frosted edges.

15. The mirror assembly of claim 14, wherein a respective one of the pair of fresnel lenses abuts each of the pair of frosted edges.

16. The mirror assembly of claim 14, wherein the light source comprises a plurality of rows of light emitting diodes (LEDs) disposed along the pair of frosted edges.

17. The mirror assembly of claim 14, further comprising:
at least one housing disposed behind the pair of frosted edges, the at least one housing including the pair of fresnel lenses and the at least one light source.

18. The mirror assembly of claim 14, further comprising:
a user input device; and
a processor configured to receive a user control signal from the user input device and control the at least one light source to increase an illuminance of the light generated by the at least one light source for a predetermined period of time in response to the user control signal.

19. The mirror assembly of claim 14, further comprising:
a battery configured to supply power to the at least one light source.

20. A method of illuminating a user of a lighted mirror, the method comprising:
generating, by a light source, light; and
refracting, by a fresnel lens, the light toward a center of the lighted mirror.
